(19) United States
(12) Patent Application Publication
(10) Pub. No.: US 2026/0064362 A1
(43) Pub. Date: Mar. 5, 2026

(54) Parameter Selection Method, Parameter Selection Apparatus, and Non-Transitory Computer-Readable Storage Medium

(71) Applicant: YAMAHA CORPORATION, Hamamatsu-shi (JP)

(72) Inventors: Yu TAKAHASHI, Hamamatsu-shi (JP); Hayato YAMAKAWA, Hamamatsu-shi (JP)

(21) Appl. No.: 19/381,229

(22) Filed: Nov. 6, 2025

Related U.S. Application Data
(63) Continuation of application No. PCT/JP2024/019315, filed on May 27, 2024.

(30) Foreign Application Priority Data
Jun. 22, 2023 (JP) 2023-102382

(51) Int. Cl. G06F 3/16

(52) U.S. Cl. CPC G06F 3/165

(57) ABSTRACT

A parameter selection method includes selecting parameters of a filter configured to take a first sound signal having a frequency characteristic to output a second sound signal having a transformed version of the frequency characteristic. The selecting includes calculating first acoustic feature quantities for the first sound signal, calculating second acoustic feature quantities for the second sound signal, and determining the parameters of the filter such that a difference in a given acoustic feature quantity related to an auditory sensation between the first acoustic feature quantities and the second acoustic feature quantities is no more than a predetermined value.

### CROSS-REFERENCE TO RELATED APPLICATIONS

The present application is a continuation application of International Application No. PCT/JP2024/019315, filed May 27, 2024, which claims priority to Japanese Patent Application No. 2023-102382, filed June 22, 2023. The contents of these applications are incorporated herein by reference in their entirety.

### BACKGROUND

The present disclosure relates to a parameter selection method, a parameter selection apparatus, and a non-transitory computer-readable storage medium.

JP 2022-077497A discloses a digital mixer that enables simultaneous display, operation, or change of a plurality of channels or a plurality of parameters.

A user (or, for example, an operator of an audio mixer) needs to select parameters for filter processing as part of initial settings.

### SUMMARY

An object of the present disclosure is to provide a sound processing method that reduces the burden on a user to do necessary task.

One aspect is a parameter selection method that includes selecting parameters of a filter configured to take a first sound signal having a frequency characteristic to output a second sound signal having a transformed version of the frequency characteristic. The selecting includes calculating first acoustic feature quantities for the first sound signal, calculating second acoustic feature quantities for the second sound signal, and determining the parameters of the filter such that a difference in a given acoustic feature quantity related to an auditory sensation between the first acoustic feature quantities and the second acoustic feature quantities is no more than a predetermined value.

Another aspect is a parameter selection apparatus that includes a processor and a memory. The memory stores instructions that, when executed by the processor, cause the processor to receive a first sound signal having a first frequency characteristic. When executed by the processor, the instructions also cause the processor to apply a filter to the first sound signal to generate a second sound signal having a modified frequency characteristic. When executed by the processor, the instructions also cause the processor to calculate first acoustic feature quantities of the first sound signal. When executed by the processor, the instructions also cause the processor to calculate second acoustic feature quantities of the second sound signal. When executed by the processor, the instructions also cause the processor to determine parameters of the filter such that a difference, in a specific acoustic feature quantity associated with auditory sensation, between the first and second acoustic feature quantities is equal to or less than a prescribed threshold.

Another aspect is a non-transitory computer-readable storage medium storing a parameter selection program executable by at least one processor of an information processing device to cause the at least one processor to execute a method that includes selecting parameters of a filter configured to take a first sound signal having a frequency characteristic to output a second sound signal having a transformed version of the frequency characteristic. The selecting includes calculating first acoustic feature quantities for the first sound signal, calculating second acoustic feature quantities for the second sound signal, and determining the parameters of the filter such that a difference in a given acoustic feature quantity related to an auditory sensation between the first acoustic feature quantities and the second acoustic feature quantities is no more than a predetermined value.

Embodiments of the present disclosure can reduce the burden on a user to do necessary task.

A more complete appreciation of the present disclosure and many of the attendant advantages thereof will be readily obtained as the same becomes better understood by reference to the following detailed description when considered in connection with the following figures, in which:

### BRIEF DESCRIPTION OF THE DRAWINGS

FIG. 1 is a block diagram of the hardware configuration of an audio mixer;

FIG. 2 illustrates the functional components of a signal processing block;

FIG. 3 is a flowchart of a parameter selection method for a filter, in accordance with an embodiment; and

FIG. 4 is a flowchart of a parameter selection method for a filter, in accordance with an alternative embodiment.

### DETAILED DESCRIPTION

The present specification is applicable to a parameter selection method, a parameter selection apparatus, and a non-transitory computer-readable storage medium.

The embodiments will now be described with reference to the accompanying drawings, wherein like reference numerals designate corresponding or identical elements throughout the various drawings. The embodiments presented below serve as illustrative examples of the present disclosure and are not intended to limit the scope of the present disclosure. In the accompanying drawings referenced in the embodiments, similar reference numerals, characters, or symbols may be used to indicate corresponding or identical elements. For example, to distinguish like elements, “A” may be appended to a reference numeral and “B” may be appended to the same reference numeral.

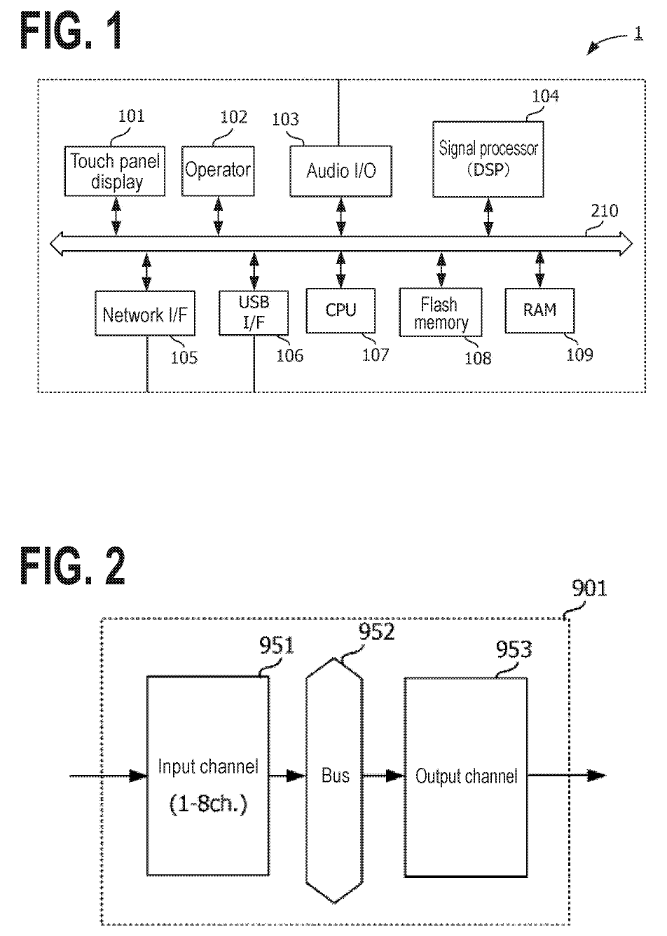

FIG. 1 is a block diagram of the hardware configuration of an audio mixer 1. FIG. 2 illustrates the functional components of a signal processing block of the audio mixer 1.

The audio mixer 1 represents an example of a parameter selection apparatus according to the present disclosure. The audio mixer 1 takes in a sound signal from an acoustic appliance such as a microphone or a musical instrument, as an input. The audio mixer 1 carries out signal processing such as mixing and effect processing on the input sound signal. The audio mixer 1 transmits the processed sound signal to a speaker or other musical appliance.

The audio mixer 1 includes a touch panel display 101, an operator 102, an audio input/output (or I/O) 103, a signal processor (or DSP) 104, a network interface (or I/F) 105, a USB I/F 106, a CPU 107, a flash memory 108, and a RAM 109. These components are coupled through a bus 210.

The CPU 107 serves as a controller that controls the operation of the audio mixer 1. The CPU 107 loads a program stored in the flash memory 108, which serves as a storage medium, in the RAM 109 for execution to implement a variety of operations. It should be understood that it is not required for the program to be stored in the flash memory 108 of the apparatus. For instance, the program may be downloaded as needed from a server or other external source and loaded into the RAM 109.

In particular, the CPU 107 handles the input and output of sound signals via the audio I/O 103, manages the mixing and effect processing at the signal processor 104, and makes changes to associated parameter values.

In one example, the touch panel display 101 includes a liquid crystal display (or LCD) and a touch-sensitive panel layered on the LCD. The touch panel display 101 displays various information under the control of the CPU 107. In addition, the touch panel display 101 accepts a user’s operations.

The operator 102 includes different operator elements such as a switch, a knob, and/or a fader to accept a user’s operations on the audio mixer 1.

The signal processor 104 is implemented by a digital signal processor (or DSP) responsible for performing a variety of signal processing including the mixing and effect processing. The signal processor 104 carries out signal processing including the mixing and/or effect processing on the incoming sound signals via the audio I/O 103, the network I/F 105, and/or the USB I/F 106. The signal processor 104 outputs the processed sound signals via the audio I/O 103, the network I/F 105, and/or the USB I/F 106.

FIG. 2 depicts a signal processing block 901, which is formed of an input channel 951, a bus 952, and an output channel 953. In the illustrated example, the input channel 951 includes eight channels (1 to 8 ch.). The bus 952 includes different buses including a stereo bus, a MIX bus, and/or a MATRIX bus. The output channel 953 serves as a block where sound signals conveyed on the different buses are processed.

At each of the channels in the input channel 951, signal processing involving a high-pass filter, a low-pass filter, an equalizer, a compressor, and/or any other suitable component is carried out on an incoming sound signal. Each of the channels in the input channel 951 sends out the processed sound signal through the downstream bus 952. The level with which the sound signals are sent out from the input channels can be adjusted by using a fader and/or any other suitable operator element, for example.

The sound signals sent out from the different input channels are mixed through the bus 952 before being fed to the output channel 953.

At the output channel 953, effect processing involving an equalizer, a compressor, and/or any other suitable component is carried out on the resultant incoming sound signal. The processed sound signal is provided to the audio I/O 103, the network I/F 105, and/or the USB I/F 106.

Hence, the signal processing block 901 functions as a filter configured to take a first sound signal having a frequency characteristic to output a second sound signal having a transformed version of the frequency characteristic.

The above-described signal processing is governed based on the values of different parameters. The CPU 107 stores in the RAM 109 the current values of the different parameters (or, in other words, the current data). The CPU 107 updates the current data in response to a user’s operations on the touch panel display 101 and/or the operator 102.

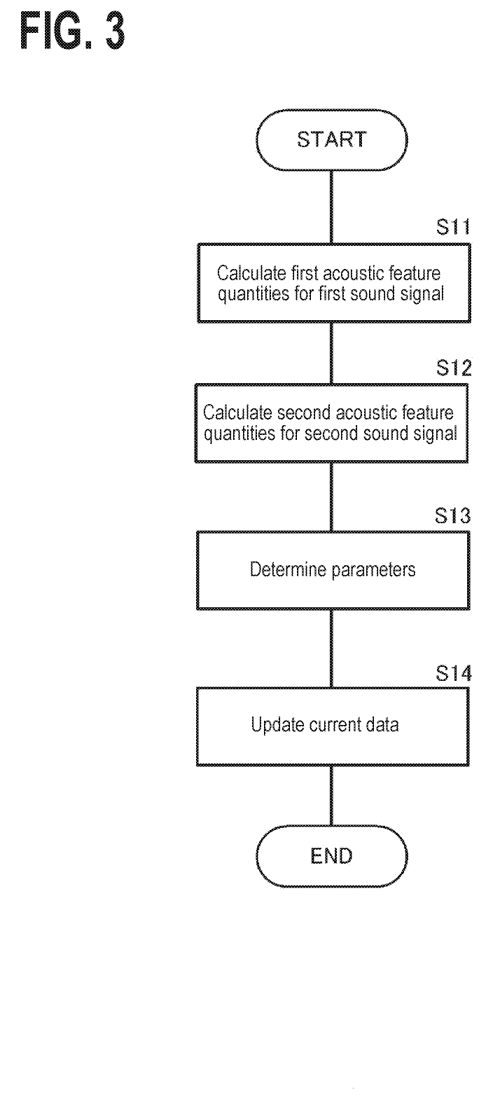

FIG. 3 is a flowchart of a parameter selection method for the filter, which method is implemented as part of the operations of the CPU 107. The CPU 107 calculates first acoustic feature quantities for the first sound signal (at step S11), and calculates second acoustic feature quantities for the second sound signal (at step S12). Then, the CPU 107 determines the parameters of the filter such that a difference in a given acoustic feature quantity related to an auditory sensation between the first acoustic feature quantities and the second acoustic feature quantities is no more than a predetermined value (at step S13).

In one example, the filter includes a high-pass filter or a low-pass filter, and the parameters determined by the CPU 107 include a cut-off frequency. The cut-off frequency of the high-pass or low-pass filter needs to be appropriately selected according to the acoustic characteristics of an acoustic appliance, which produces, as an output, the first sound signal. For example, the high-pass filter is used to remove unwanted low sound, including the hum noise of an electric musical instrument, background noise in the ambient environment, and/or noise of wind and breath caught on a microphone (or, in other words, pop noise). A higher cut-off frequency of the high-pass filter can facilitate the removal of unwanted low sound, but at the cost of a fair amount of impact on an auditory sensation because components in the relevant bandwidths of acoustic appliances may also be removed. A user should select the cut-off frequency according to the acoustic characteristics of an acoustic appliance in such an appropriate way that can remove unwanted low sound with a minimal impact on an auditory sensation.

Moreover, the audio mixer 1 includes a plurality of input channels (or, in the instant embodiment, eight input channels). Thus, a user needs to select the cut-off frequency of the high pass or low-pass filter at each of the plurality of input channels appropriately according to the acoustic characteristics of acoustic appliances associated with the different channels. The user (or, for example, an operator of the audio mixer) has to select the cut-off frequency for all of the different channels as part of initial settings and therefore bears quite a considerable burden to do the task.

According to the parameter selection method of the instant embodiment, the burden on a user to do the task is reduced through determination of the cut-off frequency in the steps S11 to S13. The CPU 107 calculates the first acoustic feature quantities for the first sound signal, and calculates the second acoustic feature quantities for the second sound signal. The first acoustic feature quantities and second acoustic feature quantities include, for example, a frequency characteristic, and, more particularly, a spectral centroid or spectral envelope.

By way of example, the CPU 107 applies a short-time Fourier transform to a sound signal to interpret the signal along a frequency axis to retrieve an amplitude spectrum for the sound signal. A computation module 52 calculates an average of the amplitude spectrum over a certain period of time, thereby acquiring an averaged spectrum. The computation module 52 removes from the averaged spectrum a bias (or, in other words, a zero-order cepstral component), which constitutes an energy component, before acquiring a spectral envelope of the resultant. It would be appreciated that either one of the averaging along a time axis or the removal of the bias may precede the other. That is, the CPU 107 may firstly remove the bias from the amplitude spectrum and subsequently calculate an average of the same along a time axis to acquire a spectral envelope of the averaged spectrum. The CPU 107 divides a frequency-weighted calculation of the overall spectral envelope by the overall spectral envelope itself to calculate a spectral centroid. In one example, at step S11, the CPU 107 calculates a first spectral centroid S1 as one of the first acoustic feature quantities for the first sound signal. In one example, at step S12, the CPU 107 calculates a second spectral centroid S2 as one of the second acoustic feature quantities for the second sound signal in an analogous way to step S11.

At step S13, the CPU 107 determines a cut-off frequency such that the ratio S2/S1 of the second spectral centroid S2 to the first spectral centroid S1 approximates a predetermined value. The predetermined value is chosen so as to not considerably alter an auditory sensation while getting rid of unwanted low sound (and may be chosen to be a value slightly greater than 1).

As mentioned earlier, a higher cut-off frequency of the high-pass filter can facilitate getting rid of unwanted low sound, but at the cost of a fair amount of impact on an auditory sensation. For the high-pass filter, a higher cut-off frequency means a higher spectral centroid, implying that the ratio S2/S1 of the second spectral centroid S2 to the first spectral centroid S1 will accordingly have a higher value. Consequently, such a ratio S2/S1 of the spectral centroids represents an example of a given acoustic feature quantity related to an auditory sensation. The CPU 107 calculates a ratio S2/S1 of the second spectral centroid S2 to the first spectral centroid S1 each time a specified interval of time passes and uses a predetermined algorithm such as, for example, a least mean square (or LMS) or a recursive least-squares (or RLS) to update the cut-off frequency in such a way that brings the value of the ratio closer to the predetermined value (at, for example, 1.02).

Alternatively, at step S13, the CPU 107 may determine a cut-off frequency such that the ratio of a spectral envelope for the second sound signal to a spectral envelope for the first sound signal approximates a predetermined value. A higher cut-off frequency results in a higher value for the ratio of the spectral envelope for the second sound signal to the spectral envelope for the first sound signal. Consequently, such a ratio of the spectral envelopes represents another example of a given acoustic feature quantity related to an auditory sensation. The CPU 107 may calculate a ratio of the spectral envelope for the second sound signal to the spectral envelope for the first sound signal each time a specified interval of time passes and use a predetermined algorithm to update the cut-off frequency in such a way that brings the value of the ratio closer to the predetermined value.

The CPU 107 updates the current data with the determined cut-off frequency for the high-pass filter (at step S14). Thereafter, the signal processing at the signal processing block 901 is carried out based on the current data as updated by the CPU 107. That is, the parameters determined by the CPU 107 are applied to the filter at the signal processing block 901 to implement sound processing involving transformation of a frequency characteristic of the first sound signal to output the second sound signal.

In this way, the parameter selection method of the instant embodiment can facilitate automated selecting of the parameters for a high-pass filter and/or other different filter(s) that will not considerably alter an auditory sensation. Hence, the burden on a user to do necessary task is reduced. In particular, the burden from the task of determining cut-off frequencies for multiple channels as in the case of audio mixers with many channels is greatly reduced. Therefore, a user can enjoy the customer experience of being able to complete initial settings in an extremely short period of time that was not possible in the past.

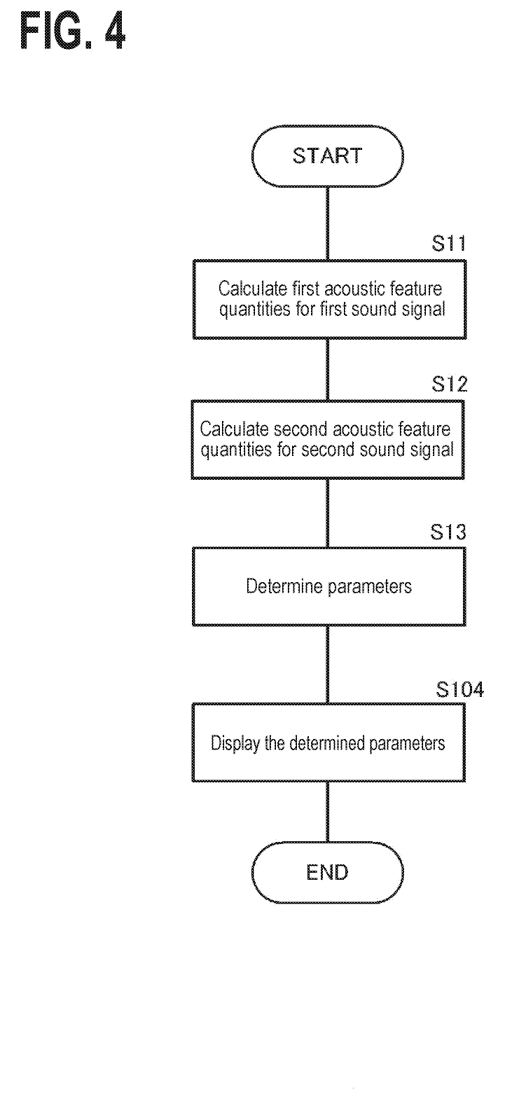

FIG. 4 is a flowchart of a parameter selection method for a filter, in accordance with an alternative embodiment. Those elements also found in FIG. 3 are, again, indicated with the same reference symbols and will not be given a lengthy description. The CPU 107 displays the determined cut-off frequency of the high-pass filter on the touch panel display 101 (at step S104).

In this scenario, a user refers to the cut-off frequency for each of the channels displayed on the touch panel display 101 to manually operate the touch panel display 101 and/or the operator 102 to set the cut-off frequency. The user can directly set the cut-off frequency as determined by the CPU 107, or modify the cut-off frequency as determined by the CPU 107 and set a modified cut-off frequency instead. For instance, the user can choose to either rely on the automated determination of the parameters by the CPU 107 or make adjustments to the parameters in accordance with his or her preference.

In another alternative embodiment, the CPU 107 may use a trained model containing a relationship between the first acoustic feature quantities, the second acoustic feature quantities, and the parameters of the filter to determine the parameters.

As mentioned earlier, the first acoustic feature quantities include, for example, a first spectral centroid, and the second acoustic feature quantities include, for example, a second spectral centroid.

As part of a training phase, the audio mixer 1 acquires multiple datasets (or pieces of training data), each including a first spectral centroid, a second spectral centroid, and a cut-off frequency parameter of a high-pass filter. The audio mixer 1 uses a predetermined algorithm to train a predetermined model to learn a relationship between the first spectral centroid, the second spectral centroid, and the cut-off frequency parameter of a high-pass filter.

Any machine learning algorithm can be used as an algorithm to train the model, including but not limited to, a convolutional neural network (or CNN) and a recurrent neural network (or RNN). Examples of the machine learning algorithm can include supervised learning, unsupervised learning, semi-supervised learning, reinforcement learning, inverse reinforcement learning, active learning, and transfer learning. Also, the computation module 52 may use a machine learning model such as a hidden Markov model (or HMM) and/or a support vector machine (or SVM) to train a model of interest.

A cut-off frequency should be optimized appropriately so as to remove unwanted low sound with a minimal impact on an auditory sensation. Specifically, the cut-off frequency is correlated with the first spectral centroid and the second spectral centroid. Thus, the audio mixer 1 can train a predetermined model of interest to learn the relationship between the first spectral centroid, the second spectral centroid, and the cut-off frequency parameter of a high-pass filter and successfully generate a trained model.

During a deployment phase, one of the first acoustic feature quantities (or the first spectral centroid) for the first sound signal and one of the second acoustic feature quantities (or the second spectral centroid) for the second sound signal can be fed as inputs by the audio mixer 1 to the trained model, which, in turn, gives an output of a cut-off frequency parameter suited for a corresponding high-pass filter.

In this way, the parameter selection method of the instant embodiment can utilize a model trained with a history of selections made by a user or users to determine the parameters for a high-pass filter and/or other different filter(s) that will not considerably alter an auditory sensation.

It is worthwhile to note that a storage medium storing a control program represented by software for realizing the present disclosure can be loaded into the parameter selection apparatus or an associated memory to produce similar advantages according to the present disclosure. In that case, the program code read from the storage medium implements a set of novel functions of the present disclosure, and the non-transitory, computer-readable storage medium storing the program code forms one aspect of the present disclosure. In some examples, the program code may also be conveyed on a propagation medium. In that case, the program code itself forms another aspect of the present disclosure. It should be noted that examples of the storage medium that can be adopted in these situations include a ROM, a diskette, a hard disk, an optical disk, a magneto-optical disk, a CD-ROM, a CD-R, a magnetic tape, and a non-volatile memory card. Examples of the non-transitory, computer-readable storage medium can even encompass those entities that retain the program for some duration of time, such as volatile memories (e.g., a DRAM (or Dynamic Random Access Memory)) within a computer system that serves as a server and/or client used to transmit the program over a network such as the Internet and/or a communication line such as a telephone line.

The foregoing description of the embodiments should be considered illustrative and not restrictive in all respects, and the scope of the present disclosure is to be defined not by the embodiments described herein but by the following claims. Moreover, the scope of the present disclosure shall encompass all that would come within the meaning of equivalency of the claims.

While embodiments of the present disclosure have been described, the embodiments are intended as illustrative only and are not intended to limit the scope of the present disclosure. It will be understood that the present disclosure can be embodied in other forms without departing from the scope of the present disclosure, and that other omissions, substitutions, additions, and/or alterations can be made to the embodiments. Thus, these embodiments and modifications thereof are intended to be encompassed by the scope of the present disclosure. The scope of the present disclosure accordingly is to be defined as set forth in the appended claims.

What is claimed is:

1. A parameter selection method comprising:
selecting parameters of a filter configured to take a first sound signal having a frequency characteristic to output a second sound signal having a transformed version of the frequency characteristic, the selecting comprising:
calculating first acoustic feature quantities for the first sound signal;
calculating second acoustic feature quantities for the second sound signal; and
determining the parameters of the filter such that a difference in a given acoustic feature quantity related to an auditory sensation between the first acoustic feature quantities and the second acoustic feature quantities is no more than a predetermined value.

2. The parameter selection method according to claim 1, wherein:
the given acoustic feature quantity comprises a spectral centroid; and
the determining comprises determining the parameters such that a ratio of a second spectral centroid for the second acoustic feature quantities to a first spectral centroid for the first acoustic feature quantities approximates a predetermined value.

3. The parameter selection method according to claim 1, wherein:
the given acoustic feature quantity comprises a spectral envelope; and
the determining comprises determining the parameters such that a ratio of a second spectral envelope for the second acoustic feature quantities to a first spectral envelope for the first acoustic feature quantities approximates a predetermined value.

4. The parameter selection method according to claim 1, further comprising:
displaying the determined parameters.

5. The parameter selection method according to claim 1, further comprising:
applying the determined parameters to the filter to implement sound processing involving transformation of the frequency characteristic of the first sound signal to output the second sound signal.

6. The parameter selection method according to claim 1, wherein the determining comprises using a trained model containing a relationship between the first acoustic feature quantities, the second acoustic feature quantities, and the parameters of the filter to determine the parameters.

7. The parameter selection method according to claim 1, wherein:
the filter comprises a high-pass filter or a low-pass filter; and
the parameters comprise a cut-off frequency.

8. A parameter selection apparatus comprising:
a processor; and
a memory storing instructions that, when executed by the processor, cause the processor to:
receive a first sound signal having a first frequency characteristic;
apply a filter to the first sound signal to generate a second sound signal having a modified frequency characteristic;
calculate first acoustic feature quantities of the first sound signal;
calculate second acoustic feature quantities of the second sound signal; and
determine parameters of the filter such that a difference, in a specific acoustic feature quantity associated with auditory sensation, between the first and second acoustic feature quantities is equal to or less than a prescribed threshold.

9. The parameter selection apparatus according to claim 8, wherein:
the given acoustic feature quantity comprises a spectral centroid; and
the determining comprises determining the parameters such that a ratio of a second spectral centroid for the second acoustic feature quantities to a first spectral centroid for the first acoustic feature quantities approximates a predetermined value.

10. The parameter selection apparatus according to claim 8, wherein:
the given acoustic feature quantity comprises a spectral envelope; and
the determining comprises determining the parameters such that a ratio of a second spectral envelope for the second acoustic feature quantities to a first spectral envelope for the first acoustic feature quantities approximates a predetermined value.

11. The parameter selection apparatus according to claim 8, wherein the instructions cause the processor to display the determined parameters on a display.

12. The parameter selection apparatus according to claim 8, wherein the instructions cause the processor to apply the determined parameters to the filter to implement sound processing involving transformation of the frequency characteristic of the first sound signal to output the second sound signal.

13. The parameter selection apparatus according to claim 8, wherein the determining comprises using a trained model containing a relationship between the first acoustic feature quantities, the second acoustic feature quantities, and the parameters of the filter to determine the parameters.

14. The parameter selection apparatus according to claim 8, wherein:
the filter comprises a high-pass filter or a low-pass filter; and
the parameters comprise a cut-off frequency.

15. A non-transitory computer-readable storage medium storing a parameter selection program executable by at least one processor of an information processing device to cause the at least one processor to execute a method comprising:
selecting parameters of a filter configured to take a first sound signal having a frequency characteristic to output a second sound signal having a transformed version of the frequency characteristic, the selecting comprising:
calculating first acoustic feature quantities for the first sound signal;
calculating second acoustic feature quantities for the second sound signal; and
determining the parameters of the filter such that a difference in a given acoustic feature quantity related to an auditory sensation between the first acoustic feature quantities and the second acoustic feature quantities is no more than a predetermined value.
